(19) United States
(12) Patent Application Publication
(10) Pub. No.: US 2008/0271351 A1
(43) Pub. Date: Nov. 6, 2008

(54) Lenticular License Plate and Method

(76) Inventor: Jay Crawford, Braselton, GA (US)

Correspondence Address: JAY CRAWFORD, 205 SATELLITE BOULEVARD, SUWANEE, GA, 30024, US

(21) Appl. No.: 11/422,394

(22) Filed: Jun. 6, 2006

Related U.S. Application Data
(60) Provisional application No. 60/688,302, filed on Jun. 7, 2005.

(51) Int. Cl. G03B 25/02; B32B 38/14; B32B 38/04

(52) U.S. Cl. 40/454; 156/277; 156/250

(57) ABSTRACT

A lenticular license plate including a lenticular lens that has a first surface and a second surface, a plurality of lenses affixed to the first surface of the lenticular lens, a lenticular image printed on a film, and the film is affixed to the second surface of the lenticular lens. The lenticular image may include at least two interlaced images.

### CROSS REFERENCE TO RELATED APPLICATIONS

This application claims priority under 35 USC § 119(e) to U.S. Provisional Patent Application 60/688,302, filed on Jun. 7, 2005, the disclosure of which is expressly incorporated herein by reference.

### TECHNICAL FIELD

The present invention relays generally to the field of license plates and more particularly relates to a system and method for producing lenticular license plates.

### BACKGROUND OF THE INVENTION

Lenticular lenses are plastic lenses consisting of an array of optical elements, or lenticules. When viewed from different angles, different areas under the lens are magnified.

Lenticular lenses can be used to create images which appear differently to the viewer depending upon the angular perspective of the viewer. To create such images, lenticular images can be specially prepared and attached to a lenticular lens. Views are arranged under the lenticules so that different views are projected. The viewer's brain then processes these views to a single coherent image. Lenticular images have previously been used as novelty items or marketing tools. However, it would be desirable to provide a license plate having a lenticular image.

### SUMMARY OF THE INVENTION

This invention provides a lenticular license plate having a lenticular lens with a first surface and a second surface. A number of lenses are affixed to the first surface of the lenticular lens. A. film is affixed to the second surface of the lenticular lens. The film has a lenticular image printed on it.

This invention also encompasses a lenticular license plate that may include a lenticular lens, The lenticular lens may include a first surface and a second surface. A number of lenses are affixed to the first surface of the lenticular lens and a lenticular image is imprinted on the second surface of the lenticular lens. The lenticular image may include two or more interlaced images.

A method for producing lenticular license plates may include the steps of providing a lenticular lens having a first surface and a second, surface printing a lenticular image onto a surface of a film, and adhering the second surface of the lenticular lens to the surface of the film having the lenticular image printed on it. Additionally, the first surface of the lenticular lens may have a number of lenses affixed to it.

### BRIEF DESCRIPTION OF THE DRAWINGS

FIG. 1 is an assembly view of the lenticular license plate system.

FIGS. 2A-2B are top and side views of a lenticular lens having a plurality of lenses affixed to a first surface of the lenticular lens.

FIG. 3 is a lenticular image printed on a film.

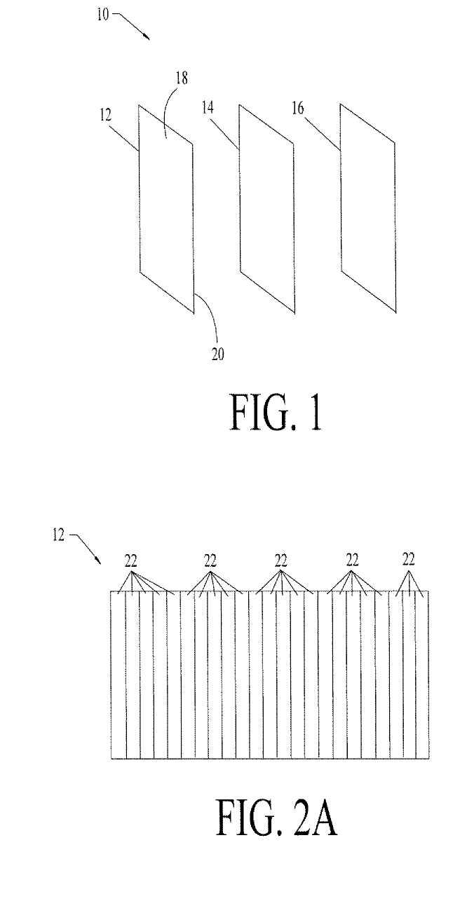

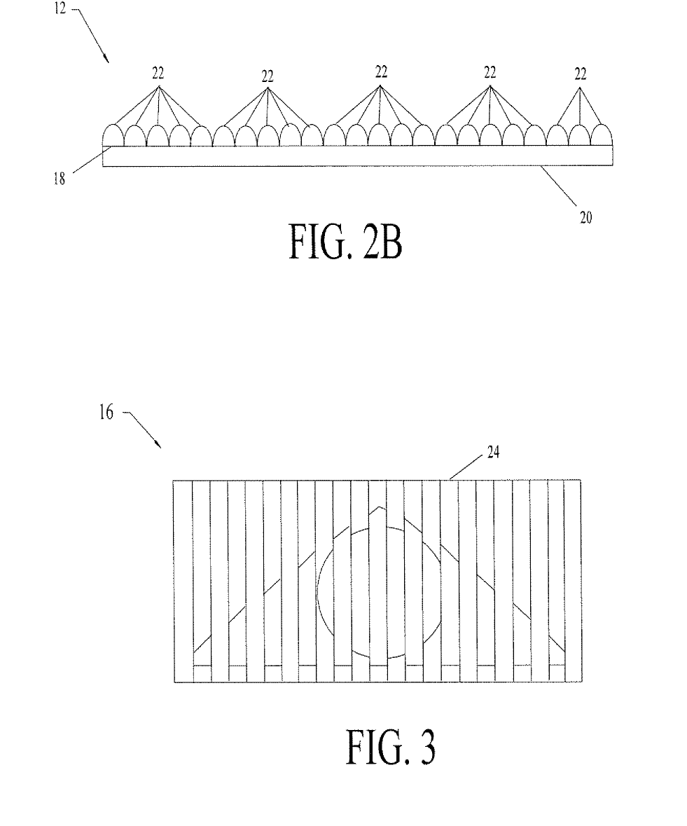

### DETAILED DESCRIPTION

The present invention now will he described more fully hereinafter with reference to the accompanying drawing, in which an exemplary embodiment of the invention is shown. This invention may, however, be embodied in many different forms and should act he construed as limited to the embodiments set forth herein; rather, this embodiment is provided so that this disclosure will be thorough and will fully convey the scope of the invention to those skilled in the art. Like numbers refer to like elements throughout.

FIG. 1 illustrates an embodiment of the lenticular license plate system 10. The lenticular license plate system 10 may include a lenticular lens 12, an adhesive 14, and a film 16. The lenticular license plate system 10 may be typical dimensions of a license plate for use on the front or back of a vehicle. The lenticular license plate system 10 allows the license plate to appear different depending upon the angular perspective of the viewer.

A lenticular image 24 may be affixed to the film 16. The film 16 may he made of any suitable material including but not limited to vinyl, polyester, polyvinyl chloride, styrene, acrylonitrile butadiene styrene, glycol-modified polyethylene terephthalate, amorphous polyethylene terephthalate, synthetic paper or natural paper. The film 16 may be white, colored, transparent, semi-transparent, opaque, or any level of transparency. The film 16 may be any thickness suitable for use with this lenticular system.

The lenticular image 24 can be any image that is desirably viewed through the lenticular lens 12. The lenticular image 24 is printed in a lenticular format. One of ordinary skill in the art will appreciate that the lenticular format allows a viewer to see differing images on the lenticular image 24 when viewed through the lenticular lens 12 depending on the viewer's angular perspective.

The lenticular image 24 may be created from a plurality of photographs, illustrations, drawings, or other images. The lenticular image may be created and printed in any manner that is appropriate for lenticular viewing. In an exemplary embodiment, the lenticular image is created using a lenticular software tool. Suitable lenticular software toots include but are not limited to POWER ILLUSION 1.75 from Photo Illusion Company, FLIP!, SUPERFLIP!, PROMAGIC, or any other lenticular software tool.

The desired images may be imported into the lenticular software tool. As known by one of ordinary skill in the art, the lenticular software generally interlaces the desired images by cutting the images into narrow strips and then interlacing the strips in the appropriate orientation for viewing through a lenticular lens. For instance, if two images are being interlaced, the software may alternate strips from the first and second images. However, any method of creating a lenticular image is contemplated herein

The lenticular image may be imported into a printing machine such as a digital offset press. The digital offset press may be used to print the lenticular image onto the film 16. The use of a digital offset printing press minimizes set-up costs because it prints only the image imported. In an exemplary embodiment, a Hewlett-Packard S2000 Digital Offset Press is used to print the lenticular image onto the film 16. One of ordinary skill in the art will appreciate that any printer or digital offset press capable of printing lenticular images is contemplated herein including but not limited to an offset printing press, a digital offset press, a flexographic printer, an inkjet printer, a roll fed ultraviolet inkjet printer, a flatbed ultraviolet inkjet printer, a screen printing machine, or a rotary screen printing machine.

If large quantities of lenticular license plates containing the same lenticular image are desired to be produced, a standard offset printing press may be used. The standard offset printing press takes longer to setup but produces lenticular images at a higher rate.

The lenticular lens 12 includes a first surface 18 and a second surface 20. The lenticular lens 12 includes lenses 22 that project from the first surface 18 of the lenticular lens. The lenses 22 may be substantially transparent. In addition, the lenses 22 may be formed from or affixed to the first surface of the lenticular lens. In one embodiment, the lenses 22 are substantially cylindrical in shape. One of ordinary skill in the art will appreciate that any shaped lens that allows the viewer to view different images based on the angular perspective is contemplated herein, including but not limited to cylindrical and fly's eye. The second surface 20 of the lens may be substantially flat for receiving the printed image.

The lenses 22 may extend either vertically or horizontally across the lenticular lens 12 based on the orientation of the printed image. For instance, if the printed image has a substantially horizontal orientation, the lenses 22 will extend substantially vertically across the lenticular lens 12.

The lenses 12 may be orientated in any density. The density of the lens 12 should correspond with strips of the lenticular image such that the viewer has the ability to see multiple images at different angular perspectives. In an exemplary embodiment, the lenticular lens 12 has a lens density of 30 lenses per inch (“Lpi”). One of ordinary skill in the art will appreciate that any lens 12 density is contemplated herein including but not limited to lens densities ranging from 20 Lpi to 200 Lpi.

The film 16 may be affixed to the lenticular lens 12 using an adhesive 14. The adhesive 14 may be any suitable adhesive that affixes the printed image to the second side of the lenticular lens. Acceptable adhesives include but are not limited to permanent adhesive (e.g., Flexcon permanent adhesive), water based adhesives, acrylic adhesives, glue, solvent based adhesives, cyanoacrylate. The adhesives 14 also may be pressure sensitive adhesives such as typical sticker adhesives.

In preparing the lenticular lens system for license plates, a lenticular lens 12 may be produced in the appropriate dimensions for a desired license plate. Likewise, the printed image may be dimensioned to correspond with the license plate. The film 16 may be affixed to the lenticular lens 12 to complete the lenticular license plate system 10.

The lenticular license plate system 10 also may be constructed from a larger lenticular lens 12. For instance, a lenticular lens 12 may be dimensioned to include multiple license plates. Likewise the film 16 may be dimensioned to include multiple license plates. After the film 16 is affixed to the lenticular leas 12, the plurality of license plates may be cut from the lenticular lens 12. Cutting may be performed automatically or manually.

Once the lenticular image is affixed to the second surface of the lenticular lens 12, the lenses of the first side of the lenticular lens 12 may be viewed through to see the images of the imprinted lenticular image. As the viewer changes his angular perspective through the lenses, the visual image of the printed image may change.

In another embodiment of the lenticular license plate, the lenticular image may be printed directly onto the second surface of the lenticular lens 12. Therefore, the use of a film 16 and an adhesive 14 are not required. The printing may be accomplished using an offset printing press, a digital offset press, a flexographic printer, an inkjet printer, a roll fed ultraviolet inkjet printer, a flatbed ultraviolet inkjet printer, a screen printing machine, a rotary screen printing machine, or any other suitable printing means.

It should be apparent that the foregoing relates only to exemplary embodiments of the present invention and that numerous changes and modifications may be made herein without departing from the spirit and scope of the invention as defined herein.

I claim:

1. A lenticular license plate comprising:
a lenticular lens comprising a first surface and a second surface;
a film affixed to the second surface of the lenticular lens, wherein a lenticular image is printed on the film; and
a plurality of lenses affixed to the first surface of the lenticular lens.

2. The lenticular license plate of claim 1, wherein the plurality of lenses are substantially transparent.

3. The lenticular license plate of claim 1, wherein the lenticular image comprises at least two interlaced images.

4. The lenticular license plate of claim 3, wherein the at least two interlaced images ate selected from a group consisting of photographs, illustrations, and drawings.

5. The lenticular license plate of claim 1, wherein the plurality of lenses comprise a substantially cylindrical shape.

6. The lenticular license plate of claim 1, wherein the plurality of lenses comprise a substantially fly's eye shape.

7. The lenticular license plate of claim 1, wherein the lenticular image is printed on the film using a lenticular software tool.

8. The lenticular license plate of claim 1, wherein the lenticular image is imprinted on the second surface of the lenticular lens using a printer selected from the group consisting of an offset printing press, a digital offset press, a flexographic printer, an inkjet printer, a roll fed ultraviolet inkjet printer, a flatbed ultraviolet inkjet printer, a screen printing machine, and a rotary screen printing machine.

9. The lenticular license plate of claim 1, wherein the film is affixed to the second surface of the lenticular lens using an adhesive.

10. The lenticular license plate of claim 9, wherein the adhesive is selected from a group consisting of a permanent adhesives, water-based adhesives, acrylic adhesives, glues, and solvent-based adhesives.

11. The lenticular license plate of claim 9, wherein the film is substantially transparent.

12. The lenticular license plate of claim 9, wherein the film is substantially opaque.

13. The lenticular license plate of claim 1, wherein the film is selected from a group consisting of vinyl, polyester, polyvinyl chloride, styrene, acrylonitrile butadiene styrene, glycol-modified polyethylene terephthalate, amorphous polyethylene terephthalate, synthetic paper, and natural paper.

14. The lenticular license plate of claim 1, wherein the plurality of lenses is formed from the first surface of the lenticular lens.

15. A method for producing lenticular license plates comprising,
providing a lenticular lens comprising a first surface and a second surface, wherein the first surface of the lenticular lens comprises a plurality of lenses;
printing a lenticular image onto a surface of a film; and
adhering the film to the second surface of the lenticular lens.

16. The method of claim 15, further comprising cutting the lenticular lens and the film to form a plurality of license plates after the film is adhered to the lenticular lens.

17. A lenticular license plate comprising:
a lenticular lens comprising a first surface and a second surface;
a plurality of lenses affixed to the first surface of the lenticular lens; and
a lenticular image imprinted on the second surface of the lenticular lens, wherein said lenticular image comprises at least two interlaced images.

18. The lenticular license plate of claim 17, wherein the plurality of lenses are substantially transparent.

19. The lenticular license plate of claim 17, wherein the lenticular image is imprinted on the second surface of the lenticular lens using a lenticular software tool.

20. The lenticular license plate of claim 17, wherein the lenticular image is imprinted on the second surface of the lenticular lens using an offset printing press, a digital offset press, a flexographic printer, an inkjet printer, a roll fed ultraviolet inkjet printer, a flatbed ultraviolet inkjet printer, a screen printing machine, or a rotary screen printing machine.
